(19) United States
(12) Patent Application Publication
(10) Pub. No.: US 2023/0009370 A1
(43) Pub. Date: Jan. 12, 2023

(54) MODEL LEARNING APPARATUS, VOICE RECOGNITION APPARATUS, METHOD AND PROGRAM THEREOF

(71) Applicant: NIPPON TELEGRAPH AND TELEPHONE CORPORATION, Tokyo (JP)

(72) Inventors: Takafumi MORIYA, Tokyo (JP); Yusuke SHINOHARA, Tokyo (JP)

(73) Assignee: NIPPON TELEGRAPH AND TELEPHONE CORPORATION, Tokyo (JP)

(21) Appl. No.: 17/783,230

(22) PCT Filed: Dec. 9, 2019
(86) PCT No.: PCT/JP2019/048079

§ 371 Date: Jun. 7, 2022

(51) Int. Cl. G10L 15/16; G10L 15/02; G10L 15/06

(52) U.S. Cl. CPC G10L 15/16; G10L 15/02; G10L 15/063

(57) ABSTRACT

A probability matrix P is obtained on the basis of an acoustic feature amount sequence, the probability matrix P being the sum for all symbols cₙ of the product of an output probability distribution vector zₙ having an element corresponding to the appearance probability of each entry k of the n-th symbol cₙ for the acoustic feature amount sequence and an attention weight vector αₙ having an element corresponding to an attention weight representing the degree of relevance of each frame t of the acoustic feature amount sequence with respect to a timing at which the symbol cₙ appears; a label sequence corresponding to the acoustic feature amount sequence in a case where a model parameter is provided is obtained; a CTC loss of the label sequence for a symbol sequence corresponding to the acoustic feature amount sequence is obtained using the symbol sequence and the label sequence; a KLD loss of the label sequence for a matrix corresponding to the probability matrix P is obtained using the matrix corresponding to the probability matrix P and the label sequence; and the model parameter is updated on the basis of an integrated loss obtained by integrating the CTC loss and the KLD loss, and the processing is repeated until an end condition is satisfied.

### TECHNICAL FIELD

The present invention relates to a model learning technique for a speech recognition technique.

### BACKGROUND ART

In a speech recognition system using a neural network in recent years, a word sequence can be directly output from an acoustic feature amount sequence. Non-Patent Literature 1 describes in sections “3. Connectionist Temporal Classification” and “4. Training the Network”, a method for learning a speech recognition model using a learning method through connectionist temporal classification (CTC). With the method described in Non-Patent Literature 1, it is not necessary to prepare a correct answer label (frame-by-frame correct answer label) for each frame for learning, and, if an acoustic feature amount sequence and a correct answer symbol sequence (correct answer symbol sequence which is not frame-by-frame) corresponding to the whole acoustic feature amount sequence are provided, a label sequence corresponding to the acoustic feature amount sequence can be dynamically obtained and a speech recognition model can be learned. Further, inference processing using the speech recognition model learned using the method in Non-Patent Literature 1 can be performed for each frame. Thus, the method in Non-Patent Literature 1 is suitable for a speech recognition system for online operation.

Meanwhile, a method using an attention-based model which learns a speech recognition model using an acoustic feature amount sequence and a correct answer symbol sequence corresponding to the acoustic feature amount sequence with higher performance than the method using the CTC has been proposed in recent years (see, for example, Non-Patent Literature 2). The method using the attention-based model performs learning while estimating a label to be output next on the basis of an attention weight calculated depending on label sequences provided so far. The attention weight indicates a frame on which an attention should be focused to determine a timing of a label to be output next. In other words, the attention weight represents the degree of relevance of each frame with respect to a timing at which the label appears. A value of the attention weight is extremely greater for an element of a frame on which a more attention should be focused to determine a timing of a label, and the value of the attention weight is small for other elements. Labeling is performed while the attention weight is taken into account, and thus, a speech recognition model learned using the method in Non-Patent Literature 2 has high performance. However, inference processing cannot be performed for each frame using the speech recognition model learned using the method in Non-Patent Literature 2, which makes it difficult to perform online operation using the method.

### CITATION LIST

### Non-Patent Literature

Non-Patent Literature 1: Alex Graves et al., “Connectionist temporal classification: Labelling unsegmented sequence data with recurrent neural networks,” ICML, pp. 369-376, 2016.

Non-Patent Literature 2: Jan Chorowski et al., “Attention-based Models for Speech Recognition,” NIPS, 2015.

### SUMMARY OF THE INVENTION

### Technical Problem

As described above, while the method in Non-Patent Literature 1 is suitable for online operation, estimation accuracy is low. Meanwhile, the method in Non-Patent Literature 2 has high estimation accuracy, but is not suitable for online operation.

The present invention has been made in view of such points and relates to a technique of learning a model which has high estimation accuracy and which is suitable for online operation.

### Means for Solving the Problem

To solve the above-described problem, a probability matrix P is obtained on the basis of an acoustic feature amount sequence, the probability matrix P being the sum for all symbols cₙ of the product of an output probability distribution vector zₙ having an element corresponding to the appearance probability of each entry k of the n-th symbol cₙ for the acoustic feature amount sequence, and an attention weight vector αₙ having an element corresponding to an attention weight representing the degree of relevance of each frame t of the acoustic feature amount sequence with respect to a timing at which the symbol cₙ appears; a label sequence corresponding to the acoustic feature amount sequence in a case where a model parameter is provided is obtained; a CTC loss of the label sequence for a correct answer symbol sequence corresponding to the acoustic feature amount sequence is obtained using the correct answer symbol sequence and the label sequence; a KLD loss of the label sequence for a matrix corresponding to the probability matrix P is obtained using the matrix corresponding to the probability matrix P and the label sequence; and the model parameter is updated on the basis of an integrated loss obtained by integrating the CTC loss and the KLD loss, and the processing is repeated until an end condition is satisfied.

### Effects of the Invention

In the present invention, a probability matrix P corresponding to an attention weight is taken into account, and thus, estimation accuracy is high. Inference processing, in which a label sequence corresponding to a new acoustic feature amount sequence in a case where a model parameter is provided is output, can be performed for each frame. In this manner, in the present invention, it is possible to learn a model which has high estimation accuracy and which is suitable for online operation.

### BRIEF DESCRIPTION OF DRAWINGS

FIG. 1 is a block diagram illustrating an example of a functional configuration of a model learning device in a first embodiment.

FIG. 2 is a block diagram illustrating an example of a hardware configuration of a model learning device in first and second embodiments.

FIG. 3 is a block diagram illustrating an example of a functional configuration of the model learning device in the second embodiment.

FIG. 4 is a block diagram illustrating an example of a functional configuration of a speech recognition device in a third embodiment.

### DESCRIPTION OF EMBODIMENTS

Embodiments of the present invention will be described below with reference to the drawings.

### First Embodiment

A first embodiment of the present invention will be described first.

### Functional Configuration of Model Learning Device 1

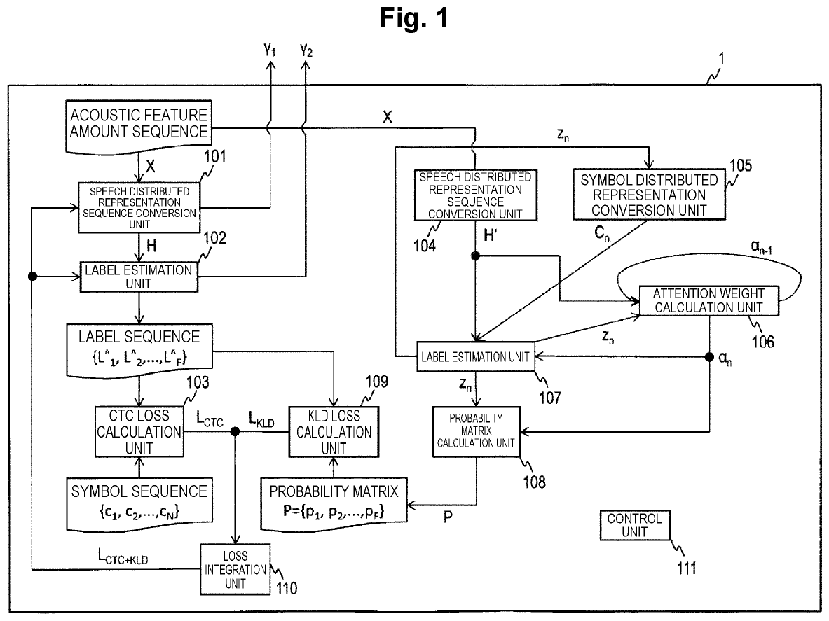

As illustrated in FIG. 1, a model learning device 1 of the present embodiment includes speech distributed representation sequence conversion units 101 and 104, a CTC loss calculation unit 103, a symbol distributed representation conversion unit 105, an attention weight calculation unit 106, label estimation units 102 and 107, a probability matrix calculation unit 108, a KLD loss calculation unit 109, a loss integration unit 110, and a control unit 111. Here, the speech distributed representation sequence conversion unit 101 and the label estimation unit 102 correspond to an estimation unit. The model learning device 1 executes respective kinds of processing on the basis of control by the control unit 111.

### Hardware and Cooperation Between Hardware and Software

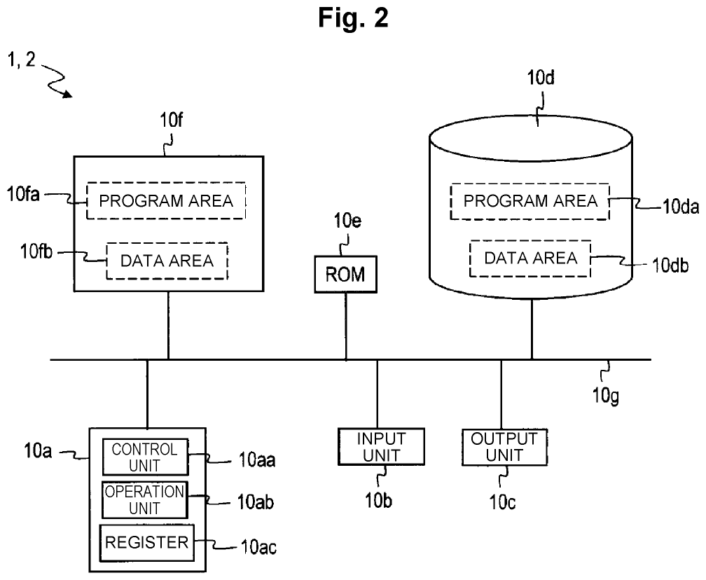

FIG. 2 illustrates an example of hardware which constitutes the model learning device 1 in the present embodiment and cooperation between the hardware and software. This configuration is merely an example and does not limit the present invention.

As illustrated in FIG. 2, the hardware constituting the model learning device 1 includes a central processing unit (CPU) 10a, an input unit 10b, an output unit 10c, an auxiliary storage device 10d, a random access memory (RAM) 10f, a read only memory (ROM) 10e and a bus 10g. The CPU 10a in this example includes a control unit 10aa, an operation unit 10ab and a register 10ac, and executes various kinds of operation processing in accordance with various kinds of programs loaded to the register 10ac. Further, the input unit 10b is an input port, a keyboard, a mouse, or the like, to which data is input, and the output unit 10c is an output port, a display, or the like, which outputs data. The auxiliary storage device 10d, which is, for example, a hard disk, a magneto-optical disc (MO), a semiconductor memory, or the like, has a program area 10da in which a program for executing processing of the present embodiment is stored and a data area 10db in which various kinds of data are stored. Further, the RAM 10f, which is a static random access memory (SRAM), a dynamic random access memory (DRAM), or the like, has a program area 10fa into which a program is written and a data area 10fb in which various kinds of data are stored. Further, the bus 10g connects the CPU 10a, the input unit 10b, the output unit 10c, the auxiliary storage device 10d, the RAM 10f and the ROM 10e so as to be able to perform communication.

For example, the CPU 10a writes a program stored in the program area 10da of the auxiliary storage device 10d in the program area 10fa of the RAM 10f in accordance with an operating system (OS) program which is loaded. In a similar manner, the CPU 10a writes data stored in the data area 10db of the auxiliary storage device 10d in the data area 10fb of the RAM 10f. Further, addresses on the RAM 10f at which the program and the data are written are stored in the register 10ac of the CPU 10a. The control unit 10aa of the CPU 10a sequentially reads out these addresses stored in the register 10ac, reads out the program and the data from the areas on the RAM 10f indicated by the readout addresses, causes the operation unit 10ab to sequentially execute operation indicated by the program and stores the operation results in the register 10ac. The model learning device 1 illustrated in FIG. 1 is constituted by the program being loaded to the CPU 10a and executed in this manner.

### Processing of Model Learning Device 1

Model learning processing by the model learning device 1 will be described.

The model learning device 1 is a device which receives input of an acoustic feature amount sequence X and a correct answer symbol sequence C={c₁, c₂, . . . , c_{N}} corresponding to the acoustic feature amount sequence X, and generates and outputs a label sequence corresponding to the acoustic feature amount sequence X. N is a positive integer and represents the number of symbols included in the correct answer symbol sequence C. The acoustic feature amount sequence X is a sequence of time-series acoustic feature amounts extracted from a time-series acoustic signal such as a speech. The acoustic feature amount sequence X is, for example, a vector. The correct answer symbol sequence C is a sequence of correct answer symbols represented by the time-series acoustic signal corresponding to the acoustic feature amount sequence X. Examples of the correct symbol can include a phoneme, a character, a sub-word and a word. Examples of the correct symbol sequence C can include a vector. While the correct answer symbol sequence C corresponds to the acoustic feature amount sequence X, to which frame (time point) of the acoustic feature amount sequence X, each correct answer symbol included in the correct answer symbol sequence C corresponds is not specified.

### Speech Distributed Representation Sequence Conversion Unit 104

The acoustic feature amount sequence X is input to the speech distributed representation sequence conversion unit 104. The speech distributed representation sequence conversion unit 104 obtains and outputs an intermediate feature amount sequence H′ corresponding to the acoustic feature amount sequence X in a case where a conversion model parameter λ₁ which is a model parameter is provided (step S104). The speech distributed representation sequence conversion unit 104, which is, for example, a multistage neural network, receives input of the acoustic feature amount sequence X and outputs the intermediate feature amount sequence H′. The conversion model parameter λ₁ of the speech distributed representation sequence conversion unit 104 is learned and set in advance. Processing at the speech distributed representation sequence conversion unit 104 is performed, for example, in accordance with an expression (17) in Reference Literature 1. Alternatively, the intermediate feature amount sequence H′ may be obtained by applying a long short-term memory (LSTM) to the acoustic feature amount sequence X in place of the expression (17) in Reference Literature 1 (see Reference Literature 2).

Reference Literature 1: Shinji Watanabe, Senior Member, Takaaki Hori, Suyoun Kim, John R. Hershey, and Tomoki Hayashi, “Hybrid CTC/Attention Architecture for End-to-End Speech Recognition”, IEEE journal of selected topics in signal processing, vol. 11, No. 8, December 2017.

### Reference Literature 2: Sepp Hochreiter, Jurgen Schmidhuber, “LONG SHORT-TERM MEMORY”, Computer Science, Medicine Published in Neural Computation 1997.

### Symbol Distributed Representation Conversion Unit 105

A label zₙ (where n=1, . . . , N) output from the label estimation unit 107 is input to the symbol distributed representation conversion unit 105 as will be described later. The symbol distributed representation conversion unit 105 converts the label zₙ into a character feature amount Cₙ which is a feature amount of a continuous value corresponding to the label zₙ in a case where a character feature amount estimation model parameter λ₃ which is a model parameter is provided (step S105). “n” represents the order of the label zₙ arranged in chronological order. The character feature amount estimation model parameter λ₃ of the symbol distributed representation conversion unit 105 is learned and set in advance. The character feature amount Cₙ is, for example, a one-hot vector in which a value of a dimension corresponding to K+1 entries (including an entry of “blank” of one redundance symbol) corresponding to the label zₙ is a value other than 0 (for example, a positive value), and values of the other dimensions are 0. K is a positive integer, and a total number of entries of the symbol is K+1. The character feature amount Cₙ is calculated using the label zₙ through, for example, an expression (4) in Non-Patent Literature 2.

### Attention Weight Calculation Unit 106

The intermediate feature amount sequence H′ output from the speech distributed representation sequence conversion unit 104 and the label zₙ output from the label estimation unit 107 are input to the attention weight calculation unit 106. The attention weight calculation unit 106 obtains and outputs an attention weight vector αₙ corresponding to the label zₙ using the intermediate feature amount sequence H′, the label zₙ and an attention weight vector αₙ₋₁ corresponding to the immediately preceding label zₙ₋₁ (step S106). The attention weight vector αₙ is an F-dimensional vector representing the attention weight. In other words, the attention weight vector αₙ is an F-dimensional vector having an element corresponding to an attention weight representing the degree of relevance of each frame t=1, . . . , F of the acoustic feature amount sequence X with respect to a timing at which the symbol cₙ appears. F is a positive integer and represents a total number of frames of the acoustic feature amount sequence X. As described above, the attention weight indicates on which frame, an attention should be focused to determine a timing of a label which is to be output next. Here, a value of an element of the attention weight vector αₙ becomes as follows. A value of the attention weight becomes extremely greater for an element of a frame on which a more attention should be focused to determine a timing of a label, and values become small for other elements. A calculation process (for example, a computation process) of the attention weight vector αₙ is described in “2.1 General Framework” in “2 Attention-Based Model for Speech Recognition” in Non-Patent Literature 2. For example, the attention weight vector αₙ is calculated in accordance with expressions (1) to (3) in Non-Patent Literature 2. For example, the number of dimensions of the attention weight vector αₙ is 1×F.

### Label Estimation Unit 107

The intermediate feature amount sequence H′ output from the speech distributed representation sequence conversion unit 104, the character feature amount Cₙ output from the symbol distributed representation conversion unit 105, and the attention weight vector αₙ output from the attention weight calculation unit 106 are input to the label estimation unit 107. The label estimation unit 107 generates and outputs an output probability distribution vector zₙ having an element corresponding to the appearance probability of each entry k (where k=1, . . . , K+1) of the n-th (where n=1, . . . , N) symbol cₙ in a case where a label estimation model parameter λ₂ which is a model parameter is provided, using the intermediate feature amount sequence H′, the character feature amount Cₙ and the attention weight vector αₙ (step S107). The label estimation model parameter λ₂ of the label estimation unit 107 is learned and set in advance. The output probability distribution vector zₙ is generated, for example, in accordance with expressions (2) and (3) in Non-Patent Literature 2.

### Probability Matrix Calculation Unit 108

The label zₙ output from the label estimation unit 107 and the attention weight vector αₙ output from the attention weight calculation unit 106 are input to the probability matrix calculation unit 108. The probability matrix calculation unit 108 obtains and outputs a probability matrix P which is the sum for all symbols cₙ (where n=1, . . . , N) of the product of the output probability distribution vector zₙ and the attention weight vector αₙ. In other words, the probability matrix calculation unit 108 calculates the probability matrix P using the following expression (1) and outputs the probability matrix P.

$$\begin{matrix}[ Math . 1 ] & \\ P = {\sum }_{n = 1}^{N} {z}_{n} {{α}_{n}}^{T} & ( 1 )\end{matrix}$$

$$where$$

$$\begin{matrix}[ Math . 2 ] & \\ P = [ \begin{matrix}{p}_{1 , 1} & … & {p}_{F , 1} \\ ⋮ & ⋱ & ⋮ \\ {p}_{1 , K + 1} & … & {p}_{F , K + 1}\end{matrix} ] & \end{matrix}$$

$$\begin{matrix}[ Math . 3 ] & \\ {z}_{n} = [ \begin{matrix}{z}_{n , 1} \\ ⋮ \\ {z}_{n , K + 1}\end{matrix} ] & \end{matrix}$$

$$\begin{matrix}[ Math . 4 ] & \\ {α}_{n} = ( {α}_{n , 1} , … , {α}_{n , F} ) & \end{matrix}$$

p_{t,k} is an element of row t and column k of the probability matrix P and corresponds to a frame t and an entry k. z_{n,k} is an element in a k-th column of the output probability distribution vector zₙ and corresponds to the entry k. α_{n,t} is a t-th element of the attention weight vector αₙ and corresponds to the frame t. β^{T} represents transposition of β. The probability matrix P is a matrix of F (the number of frames)×K+1 (the number of entries of the symbol) (step S108).

### Speech Distributed Representation Sequence Conversion Unit 101

The acoustic feature amount sequence X is input to the speech distributed representation sequence conversion unit 101. The speech distributed representation sequence conversion unit 101 obtains and outputs the intermediate feature amount sequence H corresponding to the acoustic feature amount sequence X in a case where a conversion model parameter γ₁ which is a model parameter is provided (step S101). The speech distributed representation sequence conversion unit 101 is, for example, a multistage neural network, receives input of the acoustic feature amount sequence X and outputs the intermediate feature amount sequence H. Processing of the speech distributed representation sequence conversion unit 101 is performed, for example, in accordance with an expression (17) in Reference Literature 1. Alternatively, the intermediate feature amount sequence H may be obtained by applying a long short-term memory (LSTM) to the acoustic feature amount sequence X in place of the expression (17) in Reference Literature 1.

### Label Estimation Unit 102

The intermediate feature amount sequence H output from the speech distributed representation sequence conversion unit 101 is input to the label estimation unit 102. The label estimation unit 102 obtains and outputs a label sequence {L\hat{ }₁, L\hat{ }₂, . . . , L\hat{ }_{F}} corresponding to the intermediate feature amount sequence H in a case where a label estimation model parameter γ₂ is provided (step S102). The label sequence {L\hat{ }₁, L\hat{ }₂, . . . , L\hat{ }_{F}} is a sequence of label L\hat{ }ₜ of each frame t (where t=1, . . . , F). The label L\hat{ }ₜ is output probability distribution y_{k,t} for each entry k of the symbol output at the frame t. As described above, the total number of entries k of the symbol is K+1, and k=1, . . . , K+1. The label L\hat{ }ₜ is obtained, for example, in accordance with an expression (16) in Reference Literature 1.

### CTC Loss Calculation Unit 103

The correct answer symbol sequence C={c₁, c₂, . . . , c_{N}} corresponding to the acoustic feature amount sequence X and the label sequence {L\hat{ }₁, L\hat{ }₂, . . . , L\hat{ }_{F}} output from the label estimation unit 102 are input to the CTC loss calculation unit 103. The CTC loss calculation unit 103 obtains and outputs a connectionist temporal classification (CTC) loss L_{CTC} of the label sequence {L\hat{ }₁, L\hat{ }₂, . . . , L\hat{ }_{F}} for the correct answer symbol sequence C={c₁, c₂, . . . , c_{N}} using the correct answer symbol sequence C={c₁, c₂, . . . , c_{N}} and the label sequence {L\hat{ }₁, L\hat{ }₂, . . . , L\hat{ }_{F}} (step S103). The CTC loss L_{CTC} can be obtained, for example, in accordance with an expression (14) in Non-Patent Literature 1.

### KLD Loss Calculation Unit 109

The probability matrix P output from the probability matrix calculation unit 108 and the label sequence {L\hat{ }₁, L\hat{ }₂, . . . , L\hat{ }_{F}} output from the label estimation unit 102 are input to the KLD loss calculation unit 109. The KLD loss calculation unit 109 obtains and outputs a KLD loss LKLD of the label sequence for a matrix corresponding to the probability matrix P using the probability matrix P and the label sequence {L\hat{ }₁, L\hat{ }₂, . . . , L\hat{ }_{F}} (step S109). The KLD loss L_{KLD} is an index representing how much degree the label sequence {L\hat{ }₁, L\hat{ }₂, . . . , L\hat{ }_{F}} is deviated from the probability matrix P. The KLD loss calculation unit 109, for example, obtains and outputs the KLD loss LKLD using the following expression (2).

$$\begin{matrix}[ Math . 5 ] & \\ {L}_{KLD} = - {\sum }_{t = 1}^{T} {\sum }_{k = 1}^{K + 1} {p}_{t , k} log {y}_{t , k} & ( 2 )\end{matrix}$$

Further, sums of p_{t,1}, p_{t,2}, . . . , p_{t,K+1} at respective frames t of p_{t,k} are preferably the same. For example, p_{t,1}, p_{t,2}, . . . , p_{t,K+1} are preferably normalized to the following p_{t,1}′, p_{t,2}′, . . . , p_{t,K+1}′. For example, p_{t,k} is preferably normalized to p_{t,k}′ in accordance with the following expression (3).

$$\begin{matrix}[ Math . 6 ] & \\ {p}_{t , k}^{′} = \frac{exp ( {p}_{t , k} )}{{\sum }_{k = 1}^{K + 1} exp ( {p}_{t , k} )} & ( 3 )\end{matrix}$$

In this case, the KLD loss calculation unit 109 obtains and outputs the KLD loss L_{KLD}, for example, using the following expression (4).

$$\begin{matrix}[ Math . 7 ] & \\ {L}_{KLD} = - {\sum }_{t = 1}^{T} {\sum }_{k = 1}^{K + 1} {p}_{t , k}^{′} log {y}_{t , k} & ( 4 )\end{matrix}$$

### Loss Integration Unit 110

The CTC loss L_{CTC} output from the CTC loss calculation unit 103 and the KLD loss L_{KLD} output from the KLD loss calculation unit 109 are input to the loss integration unit 110. The loss integration unit 110 obtains and outputs an integrated loss L_{CTC+KLD} obtained by integrating the CTC loss L_{CTC} and the KLD loss L_{KLD} (step S110). For example, the loss integration unit 110 integrates the losses using the following expression (5) using a coefficient λ (where 0≤λ<1) and outputs the integrated loss.

L_{CTC+KLD}=(1−λ)L_{KLD}+λL_{CTC} (5)

### Control Unit 111

The integrated loss L_{CTC+KLD} is input to the speech distributed representation sequence conversion unit 101 and the label estimation unit 102. The speech distributed representation sequence conversion unit 101 updates a conversion model parameter γ₁ on the basis of the integrated loss L_{CTC+KLD}, and the label estimation unit 102 updates the label estimation model parameter γ₂ on the basis of the integrated loss L_{CTC+KLD}. The updating is performed so that the integrated loss L_{CTC+KLD} becomes smaller. The control unit 111 causes the speech distributed representation sequence conversion unit 101 which has updated the conversion model parameter γ₁ to execute the processing in step S101, causes the label estimation unit 102 which has updated the label estimation model parameter γ₂ to execute the processing in step S102, causes the CTC loss calculation unit 103 to execute the processing in step S103, causes the KLD loss calculation unit 109 to execute the processing in step S109 and causes the loss integration unit 110 to execute the processing in step S110. In this manner, the control unit 111 updates the conversion model parameter γ₁ and the label estimation model parameter γ₂ on the basis of the integrated loss L_{CTC+KLD} and repeats the processing in step S101, the processing in step S102, the processing in step S103, the processing in step S109, and the processing in step S110 until an end condition is satisfied. The end condition is not limited, and the end condition may be a condition that the number of times of repetition reaches a threshold, a condition that a change amount of the integrated loss L_{CTC+KLD} becomes equal to or less than a threshold before and after the repetition, or a condition that a change amount of the conversion model parameter γ₁ or the label estimation model parameter γ₂ becomes equal to or less than a threshold before and after the repetition. In a case where the end condition is satisfied, the speech distributed representation sequence conversion unit 101 outputs the conversion model parameter γ₁, and the label estimation unit 102 outputs the label estimation model parameter γ₂.

### Second Embodiment

A second embodiment of the present invention will be described next.

In the first embodiment, the label sequence output from the label estimation unit 102 is utilized for both calculation of the CTC loss L_{CTC} at the CTC loss calculation unit 103 and calculation of the KLD loss L_{KLD} at the KLD loss calculation unit 109 to update the label estimation model parameter γ₂ of the label estimation unit 102. However, there is a case where the probability matrix P calculated at the probability matrix calculation unit 108 includes an error, in which case, the label estimation model parameter γ₂ may not be appropriately updated at the label estimation unit 102 as a result of the integrated loss L_{CTC+KLD} being affected by the error of the probability matrix P. Thus, a label estimation unit which estimates a label sequence to be utilized for calculation of the CTC loss LCTC at the CTC loss calculation unit 103 and a label estimation unit which estimates a label sequence to be utilized for calculation of the KLD loss L_{KLD} at the KLD loss calculation unit 109 may be separately provided. Further, it is possible to reduce influence of the error of the probability matrix P by updating the label estimation model parameter of the label estimation unit which estimates the label sequence to be utilized for calculation of the KLD loss L_{KLD} which is to be affected by the error of the probability matrix P on the basis of the CTC loss L_{CTC} which is not to be affected by the error of the probability matrix P. Differences from the first embodiment will be mainly described below, and description of matters which have already been described will be omitted.

### Functional Configuration of Model Learning Device 2

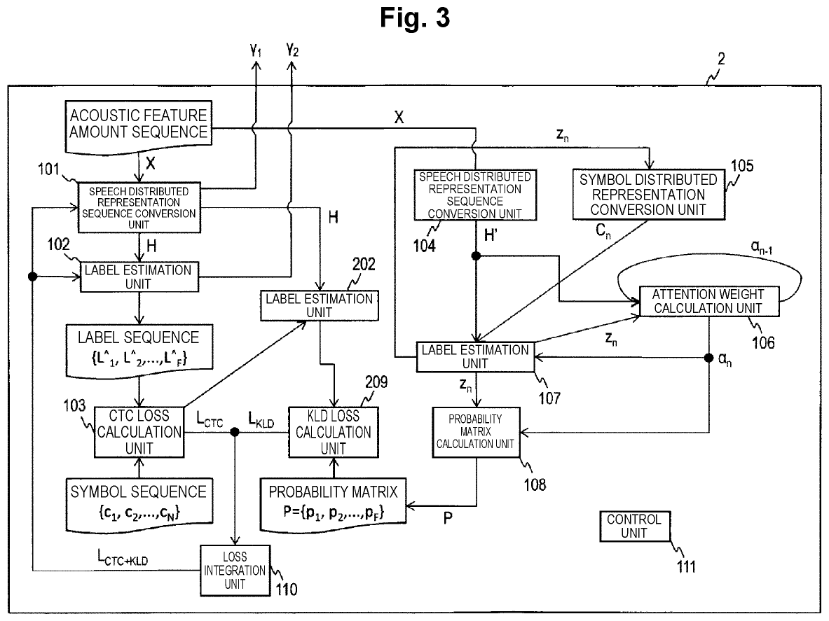

As illustrated in FIG. 3, a model learning device 2 of the present embodiment includes speech distributed representation sequence conversion units 101 and 104, a CTC loss calculation unit 103, a symbol distributed representation conversion unit 105, an attention weight calculation unit 106, label estimation units 102, 107 and 202, a probability matrix calculation unit 108, a KLD loss calculation unit 209, a loss integration unit 110 and a control unit 111. The model learning device 2 executes respective kinds of processing on the basis of control by the control unit 111.

### Hardware and Cooperation Between Hardware and Software

The hardware and the cooperation between the hardware and software are similar to those in the first embodiment, and thus, description will be omitted.

### Processing of Model Learning Device 2

Model learning processing by the model learning device 2 will be described. The second embodiment is different from the first embodiment in processing in the label estimation unit 202 and in that the KLD loss calculation unit 209 to which the label sequence generated at the label estimation unit 202 is input calculates the KLD loss L_{KLD} in place of the processing in the KLD loss calculation unit 109. The other matters are the same as those in the first embodiment. Only these differences will be described below.

### Label Estimation Unit 202

The intermediate feature amount sequence H output from the speech distributed representation sequence conversion unit 101 is input to the label estimation unit 202. The label estimation unit 202 obtains and outputs the label sequence {L\hat{ }₁, L\hat{ }₂, . . . , L\hat{ }_{F}} corresponding to the intermediate feature amount sequence H in a case where a label estimation model parameter γ₃ is provided (step S202). The label sequence {L\hat{ }₁, L\hat{ }₂, . . . , L\hat{ }_{F}} is a sequence of a label L\hat{ }ₜ of each frame t (where t=1, . . . , F). The label L\hat{ }ₜ is output probability distribution y_{k,t} for each entry k of the symbol output at the frame t. As described above, the total number of entries k of the symbol is K+1, and k=1, . . . , K+1. The label L\hat{ }ₜ′ can be obtained, for example, in accordance with an expression (16) in Reference Literature 1.

### KLD Loss Calculation Unit 209

The probability matrix P output from the probability matrix calculation unit 108 and the label sequence {L\hat{ }₁, L\hat{ }₂, . . . , L\hat{ }_{F}} output from the label estimation unit 202 are input to the KLD loss calculation unit 209. The KLD loss calculation unit 209 obtains and outputs the KLD loss L_{KLD} of the label sequence for the matrix corresponding to the probability matrix P using the probability matrix P and the label sequence {L\hat{ }₁, L\hat{ }₂, . . . , L\hat{ }_{F}} (step S209). The KLD loss L_{KLD} is an index representing how much degree the label sequence {L\hat{ }₁, L\hat{ }₂, . . . , L\hat{ }_{F}} is deviated from the probability matrix P. The KLD loss calculation unit 209 obtains and outputs the KLD loss LKLD, for example, using the above-described expression (2) or expression (4). The KLD loss LKLD output from the KLD loss calculation unit 209 is input to the loss integration unit 110.

### Control Unit 111

The integrated loss L_{CTC+KLD} is input to the speech distributed representation sequence conversion unit 101 and the label estimation unit 102. The speech distributed representation sequence conversion unit 101 updates the conversion model parameter γ₁ on the basis of the integrated loss L_{CTC+KLD}, and the label estimation unit 102 updates the label estimation model parameter γ₂ on the basis of the integrated loss L_{CTC+KLD}. The updating is performed so that the integrated loss L_{CTC+KLD} becomes smaller. Further, the CTC loss L_{CTC} output from the CTC loss calculation unit 103 is input to the label estimation unit 202. The label estimation unit 202 updates the label estimation model parameter γ₃ on the basis of the CTC loss L_{CTC}. The updating is performed so that the CTC loss L_{CTC} becomes smaller. The control unit 111 causes the speech distributed representation sequence conversion unit 101 which has updated the conversion model parameter γ₁ to execute the processing in step S101, causes the label estimation unit 102 which has updated the label estimation model parameter γ₂ to execute the processing in step S102, causes the label estimation unit 202 which has updated the label estimation model parameter γ₃ to execute the processing in step S202, causes the CTC loss calculation unit 103 to execute the processing in step S103, causes the KLD loss calculation unit 209 to execute the processing in step S209 and causes the loss integration unit 110 to execute the processing in step S110. In this manner, the control unit 111 updates the conversion model parameter γ₁ and the label estimation model parameter γ₂ (first label estimation model parameter) on the basis of the integrated loss L_{CTC+KLD}, updates the label estimation model parameter γ₃ (second label estimation model parameter) on the basis of the CTC loss L_{CTC} and repeats the processing in step S101, the processing in step S102, the processing in step S103, the processing in step S202, the processing in step S209 and the processing in step S110 until an end condition is satisfied. The end condition is not limited, and the end condition may be a condition that the number of times of repetition reaches a threshold, a condition that a change amount of the integrated loss L_{CTC+KLD} becomes equal to or less than a threshold before and after the repetition, or a condition that a change amount of the conversion model parameter γ₁, the label estimation model parameter γ₂ or the label estimation model parameter γ₃ becomes equal to or less than a threshold before and after repetition. In a case where the end condition is satisfied, the speech distributed representation sequence conversion unit 101 outputs the conversion model parameter γ₁, and the label estimation unit 102 outputs the label estimation model parameter γ₂.

### Third Embodiment

A third embodiment of the present invention will be described next. In the present embodiment, a speech recognition device constructed using the conversion model parameter γ₁ and the label estimation model parameter γ₂ output from the model learning device 1 or 2 in the first or the second embodiment will be described.

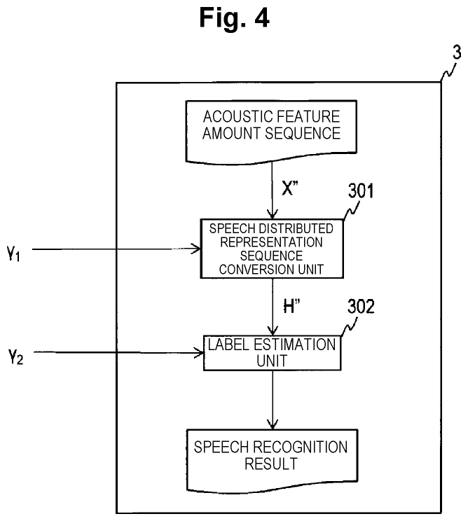

As illustrated in FIG. 4, a speech recognition device 3 of the present embodiment includes a speech distributed representation sequence conversion unit 301 and a label estimation unit 302. The speech distributed representation sequence conversion unit 301 is the same as the speech distributed representation sequence conversion unit 101 described above except that the conversion model parameter γ₁ output from the model learning device 1 or 2 is input and set. The label estimation unit 302 is the same as the label estimation unit 102 described above except that the label estimation model parameter γ₂ output from the model learning device 1 or 2 is input and set.

### Speech Distributed Representation Sequence Conversion Unit 301

An acoustic feature amount sequence X″ which is a speech recognition target is input to the speech distributed representation sequence conversion unit 301 of the speech recognition device 3. The speech distributed representation sequence conversion unit 301 obtains and outputs an intermediate feature amount sequence H″ corresponding to the acoustic feature amount sequence X″ in a case where the conversion model parameter γ₁ is provided (step S301).

### Label Estimation Unit 302

The intermediate feature amount sequence H″ output from the speech distributed representation sequence conversion unit 301 is input to the label estimation unit 302. The label estimation unit 302 obtains and outputs a label sequence {L\hat{ }₁, L\hat{ }₂, . . . , L\hat{ }_{F}} corresponding to the intermediate feature amount sequence H″ in a case where the label estimation model parameter γ₂ is provided (step S302).

### Other Modified Examples, or the Like

Note that the present invention is not limited to the above-described embodiments. For example, the above-described various kinds of processing may be executed in parallel or individually in accordance with processing performance of devices which execute the processing or as appropriate as well as being executed in chronological order in accordance with the description. Further, it goes without saying that changes can be made as appropriate within a range not deviating from the gist of the present invention.

Further, in a case where the above-described configuration is implemented with a computer, processing content of functions which should be provided at respective devices is described with a program. Further, the above-described processing functions are implemented on the computer by the program being executed at the computer. The program describing this processing content can be recorded in a computer-readable recording medium. Examples of the computer-readable recording medium can include a non-transitory recording medium. Examples of such a recording medium can include a magnetic recording device, an optical disk, a magnetooptical recording medium and a semiconductor memory.

Further, this program is distributed by, for example, a portable recording medium such as a DVD and a CD-ROM in which the program is recorded being sold, given, lent, or the like. Still further, it is also possible to employ a configuration where this program is distributed by the program being stored in a storage device of a server computer and transferred from the server computer to other computers via a network.

A computer which executes such a program, for example, first, stores a program recorded in the portable recording medium or a program transferred from the server computer in its own storage device once. Then, upon execution of the processing, this computer reads the program stored in its own storage device and executes the processing in accordance with the read program. Further, as another execution form of this program, the computer may directly read a program from the portable recording medium and execute the processing in accordance with the program, and, further, the computer may sequentially execute the processing in accordance with the received program every time the program is transferred from the server computer to this computer. Further, it is also possible to employ a configuration where the above-described processing is executed by so-called application service provider (ASP) type service which implements processing functions only by execution of an instruction and acquisition of a result without the program being transferred from the server computer to this computer. Note that, it is assumed that the program in this form includes information which is to be used for processing by an electronic computer, and which is equivalent to a program (not a direct command to the computer, but data, or the like, having property specifying processing of the computer).

Further, while, in this form, the present device is constituted by a predetermined program being executed on the computer, at least part of the processing content may be implemented with hardware.

### REFERENCE SIGNS LIST

1, 2 Model learning device
3 Speech recognition device

1. A model learning device comprising a processor configured to execute a method comprising:
obtaining, on a basis of an acoustic feature amount sequence, a probability matrix P which is the sum for all symbols cₙ of a product of an output probability distribution vector zₙ having an element corresponding to an appearance probability of each entry k of an n-th symbol cₙ for the acoustic feature amount sequence and an attention weight vector αₙ having an element corresponding to an attention weight representing a degree of relevance of each frame t of the acoustic feature amount sequence with respect to a timing at which the symbol cₙ appears;
obtaining a label sequence corresponding to the acoustic feature amount sequence in a case where a model parameter is provided;
obtaining a connectionist temporal classification (CTC) loss of the label sequence for a symbol sequence corresponding to the acoustic feature amount sequence using the symbol sequence and the label sequence;
obtaining a KLD loss of the label sequence for a matrix corresponding to the probability matrix P using the matrix corresponding to the probability matrix P and the label sequence;
updating the model parameter on a basis of an integrated loss obtained by integrating the CTC loss and the KLD loss; and
repeating the obtaining the label sequence, the obtaining the CTC loss, and the obtaining the KLD loss until an end condition is satisfied.

2. A model learning device comprising a processor configured to execute a method comprising:
obtaining, on a basis of an acoustic feature amount sequence, a probability matrix P which is the sum for all symbols cₙ of a product of an output probability distribution vector zₙ having an element corresponding to an appearance probability of each entry k of an n-th symbol cₙ for the acoustic feature amount sequence and an attention weight vector αₙ having an element corresponding to an attention weight representing a degree of relevance of each frame t of the acoustic feature amount sequence with respect to a timing at which the symbol cₙ appears;
obtaining an intermediate feature amount sequence corresponding to the acoustic feature amount sequence in a case where a conversion model parameter is provided;
obtaining a first label sequence corresponding to the intermediate feature amount sequence in a case where a first label estimation model parameter is provided;
obtaining a second label sequence corresponding to the intermediate feature amount sequence and a second label estimation model parameter using the intermediate feature amount sequence and the second label estimation model parameter;
obtaining a connectionist temporal classification (CTC) loss of the first label sequence for a symbol sequence corresponding to the acoustic feature amount sequence using the symbol sequence and the first label sequence;
obtaining a KLD loss of the second label sequence for a matrix corresponding to the probability matrix P using the matrix corresponding to the probability matrix P and the second label sequence;
updating the conversion model parameter and the first label estimation model parameter on a basis of an integrated loss obtained by integrating the CTC loss and the KLD loss;
updating the second label estimation model parameter on a basis of the CTC loss; and
repeating processing in the obtaining the intermediate feature amount sequence, the obtaining the first label sequence, the obtaining the second label sequence, the obtaining the CTC loss, and the obtaining KLD loss until an end condition is satisfied.

3. (canceled)

4. A computer implemented method for learning a model, comprising:
obtaining, on a basis of an acoustic feature amount sequence, a probability matrix P which is the sum for all symbols cₙ of a product of an output probability distribution vector zₙ having an element corresponding to an appearance probability of each entry k of an n-th symbol cₙ for the acoustic feature amount sequence and an attention weight vector αₙ having an element corresponding to an attention weight representing a degree of relevance of each frame t of the acoustic feature amount sequence with respect to a timing at which the symbol cₙ appears;
obtaining a label sequence corresponding to the acoustic feature amount sequence in a case where a model parameter is provided;
obtaining a connectionist temporal classification (CTC) loss of the label sequence for a symbol sequence corresponding to the acoustic feature amount sequence using the symbol sequence and the label sequence; and
obtaining a KLD loss of the label sequence for a matrix corresponding to the probability matrix P using the matrix corresponding to the probability matrix P and the label sequence,
wherein the model parameter is updated on a basis of an integrated loss obtained by integrating the CTC loss and the KLD loss; and
iteratively processing until an end condition is satisfied:
the obtaining the label sequence;
the obtaining the CTC loss of the label sequence; and
the obtaining the KLD loss of the laben sequence.

5-8. (canceled)

9. The model learning device according to claim 1, wherein the model parameter is at least a part of a model for speech recognition.

10. The model learning device according to claim 9, wherein the acoustic feature amount sequence is a part of training data for training the model for speech recognition.

11. The model learning device according to claim 2, wherein the model parameter is at least a part of a model for speech recognition.

12. The model learning device according to claim 11, wherein the acoustic feature amount sequence is a part of training data for training the model for speech recognition.

13. The computer implemented method according to claim 4, wherein the model parameter is at least a part of a model for speech recognition.

14. The computer implemented method according to claim 13, wherein the acoustic feature amount sequence is a part of training data for training the model for speech recognition.
